(19) United States
(12) Patent Application Publication
(10) Pub. No.: US 2009/0016842 A1
(43) Pub. Date: Jan. 15, 2009

(54) BLIND RIVET IN PARTICULAR FOR FIXING A STRUCTURE AND METHOD FOR INSERTING SAME

(76) Inventors: Pierre Auriol, Flourens (FR); Jean-Marc Auriol, Flourens (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/065,087

(22) PCT Filed: Jul. 28, 2006
(86) PCT No.: PCT/FR2006/050764

§ 371 Date: Mar. 18, 2008

(30) Foreign Application Priority Data
Aug. 29, 2005 (FR) 0552593

(51) Int. Cl. F16B 19/10

(52) U.S. Cl. 411/43

(57) ABSTRACT

The invention concerns a blind rivet (R) of the type consisting of a deformable bushing (300) and a cleavable mandrel (400), the thus formed assembly being urged to be positioned and pass through the orifices (110 and 120) made substantially coaxial and provided in at least two elements (100 and 200) to be assembled. Said rivet is characterized in that the bushing (300) consists of one single piece but preformed to have a second end (320) in two parts (330 and 340) which, under the action of an axial load (arrow F), are cleaved apart so that one part of the bushing (330) moved by the tensile load of the mandrel (400) is urged to be opened around the fixed part of the bushing (340), the expansion of the mobile part (330) called sleeve being produced without folding. The invention also concerns a method for inserting such a rivet. The invention is applicable to rivet fixing.

### FIELD OF APPLICATION OF THE INVENTION

The present invention relates to the field of blind rivet type fixings and in particular to the adaptations making it possible to distribute the clamping forces of these rivets under the best conditions.

### DESCRIPTION OF THE PRIOR ART

Conventionally, a blind rivet comprises a tubular sleeve and a pulling mandrel passing through said sleeve. The rivet is placed in a hole passing through the elements to be assembled. The sleeve comprises on a first end a head leaning on a first element. The sleeve comprises a second, non-shouldered, end that extends beyond the second element.

Pulling the mandrel provides deformation of the non-shouldered end of the sleeve so as to clamp the elements between the shoulder of the sleeve and its deformed end (bulb). The surface area of the bulb in contact with the second element determines the distribution of the clamping forces of the rivet on the elements to be assembled.

Enlarging this contact surface area is a constant concern of rivet designers in order to optimize the distribution of the clamping forces.

The prior art offers sleeves in two parts, that is to say whereof the non-shouldered end is divided into two separate parts, namely:
a first stationary part; and
a second movable part that moves and deforms under the pulling force over and around the stationary part in order to finally offer, by opening out over the stationary part, an enlarged surface area for the distribution of forces on the second element.

The main drawback of this type of rivet is that it requires the manufacture and management of a rivet comprising three elements.

The prior art also offers sleeves in a single part but whereof the non-shouldered end has bending grooves in order that, once subjected to the pulling force of the mandrel, the wall of the sleeve bends in order to double the support surface created by the bulb.

The main drawback of the bending technique is not avoiding the final breaking of the bulb into two parts and requiring more material.

The document GB 1 604 502 describes a blind rivet of the type of that consisting of a deformable sleeve and a divisible mandrel, the assembly thus formed being positioned and passing through the apertures made substantially coaxial and formed in at least two elements to be assembled, the sleeve comprising two ends:

a first end comprising a preformed head for defining a first support surface on the external surface of a first element, and

a second end which, under the action of deformation by pulling on the mandrel, comes to define a second support surface on the external surface of the second element,

prolonging the force having the effect of bringing the two support surfaces closer together and consequently bringing closer together the two elements to be assembled.

The sleeve consists of a single piece, but is preformed in order to have a second end in two parts which, under the action of an axial force, whereof a first part opens out over the sleeve part that remained stationary and then separates from the latter by breaking, the expansion of the movable part referred to as a collar being done with internal bending of its end onto itself in order to form a flange.

### DESCRIPTION OF THE INVENTION

Starting from this established fact, the applicants carried out research aimed at proposing a blind rivet capable of solving the problems of distribution of the clamping forces by equipping the blind rivet with an improved sleeve which, under the action of the pulling force generated by the mandrel, deforms to offer a larger contact surface of the bulb with the metal sheet.

The blind rivet of the invention is of the type of that consisting of a deformable sleeve accommodating a divisible mandrel,

the assembly thus formed being positioned and passing through the apertures made substantially coaxial and formed in at least two elements to be assembled,

the sleeve comprising two ends:

a first end comprising a preformed head for defining a first support surface on the external surface of a first element, and

a second end which, under the action of deformation by pulling on the mandrel, comes to define a second support surface on the external surface of the second element,

prolonging the force having the effect of bringing the two support surfaces closer together and consequently bringing closer together the two elements to be assembled.

In accordance with the invention, the rivet is remarkable in that the sleeve consists of a single piece, but is preformed in order to have a second end divided into two parts connected by an easily broken part and which, under the action of an axial force, separate by breaking of the easily broken part so that a sleeve part set in motion by the pulling force of the mandrel opens out around the sleeve part that remained stationary, the expansion of the movable part referred to as a collar being done without bending. The rivet of the invention therefore changes from a configuration where it consists of two distinct pieces (a mandrel and a sleeve) to, once fitted, a configuration where it consists of three pieces (mandrel, crimping sleeve, and clamping sleeve).

This rivet is particularly advantageous in that it offers an enlarged support surface, as a result of the opening out, for transmission of the pulling force which contributes towards better clamping by the mandrel. This mandrel is preformed with a plurality of serrations onto which the head of the sleeve is crimped which contributes towards maintenance of the clamping by the mandrel.

The rivet of the invention provides this function without pre-cutting its sleeve into two parts. This is because the sleeve of the rivet of the invention is in a single part and it is only under the pulling force produced on the mandrel that the two parts of the non-shouldered end of the sleeve separate. Packaging and use of this rivet are greatly facilitated thereby since only two elements have to be managed.

The phases of fitting of the rivet of the invention are as follows:
pulling exerted on the mandrel
breaking of the sleeve into two pieces
opening out and leaning of the clamping sleeve on one element
crimping of the crimping sleeve in the grooves or serrations of the mandrel
breaking of the mandrel at its fracture groove.

In order to carry out this opening out, the sleeve is formed internally and externally with fracture areas and conical areas. Similarly, the head of the mandrel and the non-shouldered end of the sleeve with which it is brought into contact adopt an inclined contact surface so as to distribute the pulling force well.

To do this, the end of the movable part of the sleeve opening out over the stationary sleeve part is advantageously preformed internally with a conical shape which slides over the stationary part. Similarly, the end of the stationary sleeve part over which the collar opens out adopts a conical external shape.

Although the document GB 1 604 502 effectively describes a sleeve in a single piece, it does not describe breaking prior to the opening out. Moreover, this document describes a bulb, that is to say that the movable part of the sleeve will form a bulge. This bulge consists of a consequent radial extension towards the outside of the movable part of the sleeve with a bend area distant from the end thereof in order to finally form a support flange.

Apart from the fact that the creation of a bulge-based bulb is not the effect sought in the rivet of the invention, it seems important to recall the technical effect sought in the type of rivet of the invention, namely that the blind part must have substantially the same height from one rivet to another, and from one thickness to be clamped to another. Thus, the opening-out part is not deformed in order to avoid the creation of a bulge whereof the variation is liable to make the height of the fitted blind part vary. In the invention, this requirement is satisfied by the fact that the sleeve is initially in a single piece and (consequently) in one and the same material. Locking is achieved by crimping the sleeve head onto the serrations provided for that purpose in the mandrel. A constant height of the blind part guarantees good clamping irrespective of the thickness to be clamped.

In the invention, the displacement of the mandrel depends on the thickness to be clamped, which makes it possible to obtain good crimping irrespective of where located in the clamping range of the fixing. The breaking before opening out defined by the wording of the first claim plays a part in maintaining the height of the movable part of the sleeve by avoiding any deformation before breaking. Moreover, in the invention, the deformation following breaking is only an opening out around the stationary part and does not require a consequent bending liable to modify the height of the movable part or make the limit of resistance to elastic deformation thereof be exceeded. Crimping is carried out before the pulling force exceeds the limit of resistance to elastic deformation of the opened-out movable part and therefore before this part varies in height.

The breaking before opening out also avoids too great an amplitude of deformation before clamping, an amplitude which would have as a consequence the formation of cracks in the metal. Thus, another object of the invention relates to a fitting method which is remarkable in that it consists of providing the breaking of the sleeve into two parts before starting the expansion of the movable part.

Moreover, in order to guarantee a constant height for the blind part of the fixing, the method is remarkable in that it consists of crimping the head of the sleeve on the serrations of the mandrel once the movable part of the sleeve is leaning on the element to be fixed and before the exceeding of a pulling force corresponding to the maximum limit of resistance to elastic deformation of said movable part once opened out.

With the fundamental concepts of the invention having just been described above in their most elementary form, other details and characteristics will emerge more clearly from a reading of the following description and with reference to the accompanying drawings, giving by way of a non-limiting example one embodiment of a rivet in accordance with the invention.

### BRIEF DESCRIPTION OF THE DRAWINGS

FIG. 1 is a schematic drawing of a sectional view of one embodiment of a rivet in accordance with the invention and installed in a hole passing through two elements;

FIGS. 2a, 2b, 2c illustrate the deformation of the rivet illustrated in FIG. 1.

### DESCRIPTION OF PREFERRED EMBODIMENTS

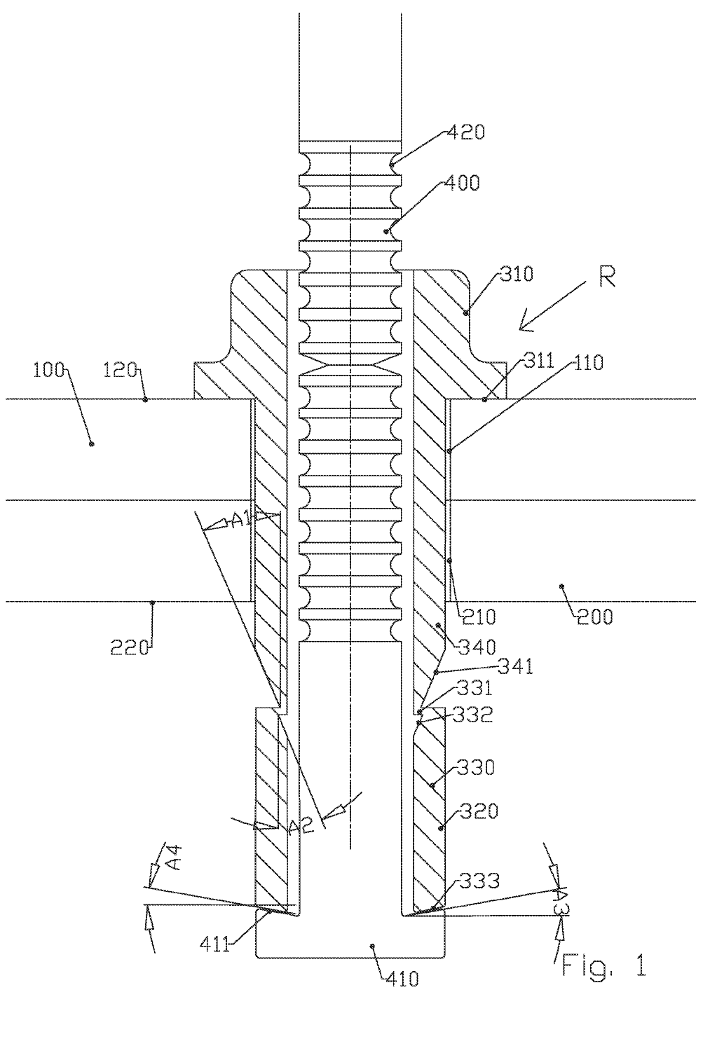

As illustrated in the drawing of FIG. 1, the blind rivet referenced R in its entirety provides the assembling of at least two elements 100 and 200. This rivet R is an assembly consisting of a deformable sleeve 300 and a divisible mandrel 400. As illustrated, the assembly thus formed is positioned and passes through two apertures 110 and 210 made substantially coaxial and formed in the elements 100 and 200 to be assembled.

The sleeve 300 comprises two ends:
a first end 310 comprising a preformed protruding head for defining a first support surface 311 on the external surface 120 of a first element 100, and
a second end 320 which, under the action of deformation by pulling on the mandrel 400, comes to define a second support surface on the external surface 220 of said second element 200.

Prolonging the force has the effects of bringing the two support surfaces closer together and as a result bringing closer together and fixing the two elements 100 and 200 to be assembled.

As illustrated, the mandrel 400 has two ends:
a first end comprising a head 410 which comes to lean on the sleeve 300 during the pulling force in order to deform it to create a bulb, and
a second end with which the pulling module of the fitting tool comes to be associated.

In accordance with the invention, the sleeve 300 consists of a single piece, but is preformed to have a second end in two parts which, under the action of an axial force, separate by breaking so that a sleeve part 330 set in motion by the pulling force of the mandrel 400 opens out around the sleeve part 340 that remained stationary, the expansion of the movable part 330 referred to as a collar being done without bending.

As illustrated by the drawing of FIG. 1, the collar 330 is connected to the rest of the sleeve by means of an easily broken part or fracture area 331.

Moreover, the end of the collar 330 that comes to open out over the stationary sleeve part 340 is advantageously preformed internally with a conical shape 332 that slides over the external conical shape 341 of the stationary part 340.

According to a preferred but non-limiting embodiment, the angle formed by the surfaces 332 and 341 belonging respectively to the collar 330 and the stationary part of the sleeve 340 and coming into contact during the opening out was the subject of a study so as to optimize the opening out of the sleeve in order to avoid in particular the creation of cracks. Thus, according to a preferred embodiment, the angle A1 formed by the conical surface 341 belonging to the stationary part of the sleeve lies between 14 and 19 degrees, and the angle A2 formed by the conical surface 341 belonging to the movable part or collar 330 lies between 5 and 10 degrees. According to another embodiment, the angle A1 lies between 10 and 19 degrees.

The correct determination of these angles allows the movable part forming the clamping collar to slide over the sleeve once breaking has occurred. Moreover, it makes it possible to reduce the frictional force between the two parts of the sleeve. There is therefore no obstacle to the sliding of the movable part which will only get bigger without its edges turning over.

Moreover, in order to optimize the pulling forces, the end of the collar 330 coming into contact with the head 410 of the mandrel 400 is preformed with a conical surface 333 coming into correspondence with a conical surface 411 made on the head 410 of the mandrel 400.

According to one embodiment, the angle of the tapered surfaces (333 and 411), belonging respectively to the collar (330) and the mandrel head (410) and remaining in contact during the riveting, is equal for the two tapered surfaces to approximately 25 degrees.

According to another preferred but non-limiting embodiment, the angle A3 of the tapered surface 411 belonging to the collar is equal to approximately 25 degrees. The angle A4 of the tapered surface 333 belonging to the mandrel and remaining in contact during riveting with the tapered surface 411 is equal to approximately 18 degrees.

This angle improves the positioning of the sleeve 300 on the mandrel 400 and avoids any slipping out of the sleeve during fitting. The difference in angle makes it possible to carry out auto-centring of the pieces coming into contact.

According to another particularly advantageous characteristic of the invention, the sleeve 300 is made from an aluminium alloy such as for example the alloy known by the designation 2017 T4 whereof the mechanical strength lies between 420 and 520 MPa. The sleeve can of course be envisaged in other materials such as those known by the following designations:
2024T4
304 stainless steel
titanium/niobium
etc.

According to another particularly advantageous characteristic of the invention, the mandrel 400 has a mechanical strength lying between 1500 and 2000 MPa. According to another characteristic, the mandrel 400 has a mechanical strength lying between 1200 and 2000 MPa.

According to a preferred embodiment, this mandrel is made from stainless steel known by the stainless steel designation AISI 302. According to another preferred embodiment, this mandrel is made from stainless steel known by the stainless steel designation AISI 304. According to another embodiment, the mandrel is made from a strain-hardened stainless steel. This material has a high modulus of elasticity which minimizes the elastic relaxation after breaking of said mandrel.

This mandrel can of course be made from other materials such as titanium known by the designation TA6V.

Moreover, for certain material, an annealing heat treatment is also provided in order to increase the stiffness of the material and thus reduce its elastic relaxation. This is because the applicants have the objective of reducing the elastic relaxation of the mandrel in order to reduce the stress relief in the elements to be assembled after breaking which has the effect of increasing the clamping. Thus, the holding force of the fixing once fitted lies between 50 and 70% of the pulling force exerted by the mandrel.

The association of the two materials used respectively for the sleeve and for the mandrel contributes towards the setting up of an installed tension.

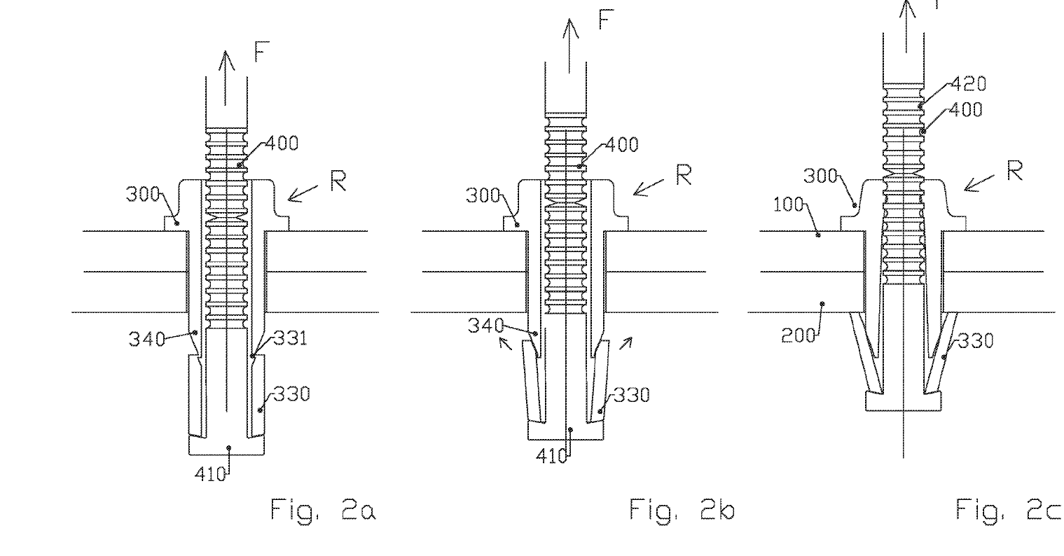

FIGS. 2a, 2b and 2c show, in sectional view, the progressive deformation of the collar 330 after the sleeve 300 has split into two parts.

The first force F to which the sleeve 300 is subjected breaks the fracture area 331 (see FIG. 2a). Continuation of the force F ensures the opening out of the collar 330 around the stationary part 340 of the sleeve 300 (see FIG. 2b). Moreover, continuation of the pulling force F continues the opening out until the collar covers the stationary part 340 and comes into contact with the element to be assembled 200 (see FIG. 2c). The sleeve head 310 will then be crimped onto the serrations 420 of the mandrel 400. The disposition of these serrations 420 is particularly important in that they guarantee the crimping of the head 310 irrespective of the thickness to be clamped. This is because, in the invention, the height of the blind part remains constant on account of the fact that, once opened out and in contact with the element to be fixed 200, the movable part 330 of the sleeve 300 does not deform any more.

As illustrated, the support surface of the bulb formed by the deformation of the non-shouldered end of the sleeve 300 of the rivet R in accordance with the invention is greatly enlarged thus meeting the requirements of the users of such rivets.

The forces taking part in the method for fitting this rivet can be broken down as follows:
F1=pulling force on the mandrel
F2=resistance-to-tearing-off force of the fixing
F3=installed tension of the fixing
F4=force for breaking the sleeve into two parts
F5=force for opening out the movable sleeve part over the stationary part of the sleeve
F6=extrusion start force of the crimping grooves

The method of the invention is remarkable in that it consists of crimping the head of the sleeve onto the serrations of the mandrel once the movable part of the sleeve is leaning on the element to be fixed and before exceeding of a pulling force corresponding to the maximum limit of resistance to elastic deformation of said movable part once opened out. According to the breakdown of the forces made above, the method is summarized by the following inequalities: F4<F5<F6<F1.

Continuation of the pulling force causes breaking of the mandrel at the fracture groove provided for that purpose.

It should be understood that the rivet R and its fitting method which have just been described and depicted above, have been so with a view to a disclosure rather than a limitation. Of course, various arrangements, modifications and improvements can be made to the example above, without for all that departing from the scope of the invention.

Thus, for example, geometrical modifications are capable of being made, most particularly if a version of this rivet is developed with swelling (the mandrel makes the sleeve swell by a few hundredths of a millimetre in order to introduce radial and tangential stresses into the hole for increasing fatigue resistance).

Also, depending on the materials used, a surface treatment is performed for the purposes of protecting against corrosion. Moreover, the sleeves can be lubricated in order to reduce the forces due to friction in particular when the collar slides over the stationary part of the sleeve and during extrusion of the sleeve into the fixing nose of the tool.

1. Blind rivet including a deformable sleeve and a divisible mandrel,
the assembly thus formed being positioned and passing through the apertures made substantially coaxial and formed in at least two elements to be assembled,
the sleeve comprising two ends:
a first end comprising a preformed head for defining a first support surface on the external surface of a first element, and
a second end which, under the action of deformation by pulling on the mandrel, comes to define a second support surface on the external surface of the second element,
prolonging the force having the effect of bringing the two support surfaces closer together and consequently bringing closer together the two elements to be assembled, characterised by the fact that the sleeve consists of a single piece, and is preformed in order to have a second end in two parts which, under the action of an axial force, separate by breaking before a sleeve part, set in motion by the pulling force of the mandrel, opens out around the sleeve part that remained stationary, the expansion of the movable part referred to as a collar being done without bending.

2. Rivet according to claim 1, characterised by the fact that the end of the movable sleeve part that comes to open out over the stationary sleeve part is advantageously preformed internally with a conical shape that slides over the stationary part.

3. Rivet according to claim 1, characterised by the fact that the end of the stationary sleeve part over which the movable sleeve part opens out adopts a conical external shape.

4. Rivet according to claim 3, characterised by the fact that the angle formed by the conical surface belonging to the stationary part of the sleeve lies between 14 and 19 degrees.

5. Rivet according to claim 3, characterised by the fact that the angle formed by the conical surface belonging to the stationary part of the sleeve lies between 10 and 19 degrees.

6. Rivet according to claim 2, characterised by the fact that the angle formed by the internal conical surface belonging to the movable part lies between 5 and 10 degrees.

7. Rivet according to claim 1, characterised by the fact that said sleeve is made from an aluminium alloy.

8. Rivet according to claim 1, characterised by the fact that said mandrel is made from a stainless steel.

9. Rivet according to claim 1, characterised by the fact that the mandrel has a mechanical strength lying between 1500 and 2000 MPa.

10. Rivet according to claim 1, characterised by the fact that the mandrel has a mechanical strength lying between 1200 and 2000 MPa.

11. Rivet according to claim 1, characterised by the fact that the end of the collar coming into contact with the head of the mandrel is preformed with a conical surface coming into correspondence with a conical surface made on the head of the mandrel.

12. Rivet according to claim 11, characterised by the fact that the angle of the tapered surfaces, belonging respectively to the collar and the mandrel head and remaining in contact during the riveting, is equal to approximately 25 degrees.

13. Rivet according to claim 9, characterised by the fact that the angle of the tapered surface belonging to the collar is equal to approximately 25 degrees and the angle of the tapered surface belonging to the mandrel and remaining in contact during the riveting with the tapered surface is equal to approximately 18 degrees.

14. Rivet according to claim 1, characterised by the fact that said mandrel is preformed with a plurality of serrations onto which the head of the sleeve is crimped.

15. (canceled)

16. Method of fitting a rivet according to claim 1, characterised in that it includes crimping the head of the sleeve onto the serrations of the mandrel once the movable part of the sleeve is leaning on the element to be fixed and before exceeding of a pulling force corresponding to the maximum limit of resistance to elastic deformation of said movable part once opened out.
